(19) United States
(12) Patent Application Publication
(10) Pub. No.: US 2013/0010109 A1
(43) Pub. Date: Jan. 10, 2013

(54) TRAIL CAMERA

(75) Inventors: Yen-Chao CHEN, Taichung (TW); Shih-Ming LEE, Taichung (TW); Hsih-Hsien YANG, Taichung (TW)

(73) Assignee: ASIA OPTICAL CO., INC., Taichung (TW)

(21) Appl. No.: 13/425,854

(22) Filed: Mar. 21, 2012

Related U.S. Application Data
(63) Continuation-in-part of application No. 13/327,981, filed on Dec. 16, 2011.

(30) Foreign Application Priority Data
Jul. 8, 2011 (TW) 100124258

(51) Int. Cl. H04N 7/18

(52) U.S. Cl. 348/143; 348/E07.085

(57) ABSTRACT

A trail camera includes a lens and at least one sensor. The lens includes a plurality of sensing areas having different sensing angles separately. Each of the sensing areas can collect the light, and the light focuses on the at least one sensor after passing through the lens. The focuses do not overlap one another. Each of the at least one sensor is located at one of imaging positions of the focuses. The at least one sensor can optionally be activated to receive the light collected form the aforesaid sensing areas for the purpose of optionally changing the tracking range. The at least one sensor or the lens each can alter their positions to make the light focus on the sensor, so the number of the sensor or lens applied to the present invention can be reduced.

### CROSS-REFERENCE TO RELATED APPLICATIONS

This application is a Continuation-in-Part of co-pending application Ser. No. 13/327,981, filed on Dec. 16, 2011, and for which priority is claimed under 35 U.S.C. §120; and this application claims priority of Application No. 100124258 filed in Taiwan on Jul. 8, 2011 under 35 U.S.C. §119, the entire contents of all of which are hereby incorporated by reference.

### BACKGROUND OF THE INVENTION

1. Field of the Invention

The present invention relates generally to an image tracking device, and more particularly, to a trail camera whose tracking range can be optionally changed.

2. Description of the Related Art

Taiwan Patent Laid-Open No. 200951884 disclosed a monitoring system and a control method thereof, in which two sensors divide the area near the monitoring system into four different sensing areas. When an object enters the so-called overlapped sensing area, the control unit can make the photographic apparatus photograph.

However, the aforesaid monitoring system can frequently make the overlapped sensing area be oversize or undersize subject to the difference of environment where the monitoring system is installed and after the monitoring system is installed, it fails to adjust the overlapped sensing area. Thus, the aforesaid prior art hardly satisfies the user's needs under different operational circumstances.

### SUMMARY OF THE INVENTION

The primary objective of the present invention is to provide a trail camera, whose tracking range can be optionally changed to satisfy the user's different needs.

The secondary objective of the present invention is to provide a trail camera, which need less required elements than the prior art because in present invention the position of the lens or sensor can be moved.

The foregoing objectives of the present invention are attained by the trail camera composed of at least one lens and at least one sensor. The at least one lens includes a plurality of sensing areas having different sensing angles respectively. Each of the sensing areas can collect the light to have a focus and the light focuses on the at least one sensor after passing through the lens. The focuses do not overlap one another. Each of the at least one sensor is located at one of the imaging positions of the focuses. The at least one sensor can optionally be activated to receive the light collected form the aforesaid sensing areas for the purpose of optionally changing the tracking range. The at least one sensor and the at least one lens each can alter their positions to make the light focus on the sensor, so the number of the sensor or lens applied to the present invention can be reduced.

In a preferred embodiment, the trail camera of the present invention further includes a controller electrically connected with a temperature sensor for allowing the controller to adjust two-limited comparison voltage via temperature change detected by the temperature sensor. Besides, the controller can be electrically connected with an image capturing device for emitting a shutter signal to the image capturing for photographing upon receipt of a trigger signal from the sensor.

In a preferred embodiment, the trail camera of the present invention further includes a control device for controlling movement or rotation of the at least one sensor or lens to enable the light to focus on the at least one sensor, after passing through the lens.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is an exploded view of a part of the first preferred embodiment of the present invention.

FIG. 4 is a partially top view of the first preferred embodiment of the present invention.

FIG. 5 similar to FIG. 4 is another partially top view of the first preferred embodiment of the present invention.

FIG. 6 is a block diagram of the first preferred embodiment of the present invention.

FIG. 7 is an exploded view of a part of a second preferred embodiment of the present invention.

FIG. 8A is an exploded view of a part of a third preferred embodiment of the present invention.

FIG. 8B is an exploded view of a part of the third preferred embodiment of the present invention.

FIG. 9A is an exploded view of a part of a fourth preferred embodiment of the present invention.

FIG. 9B is an exploded view of a part of the fourth preferred embodiment of the present invention.

### DETAILED DESCRIPTION OF PREFERRED EMBODIMENTS

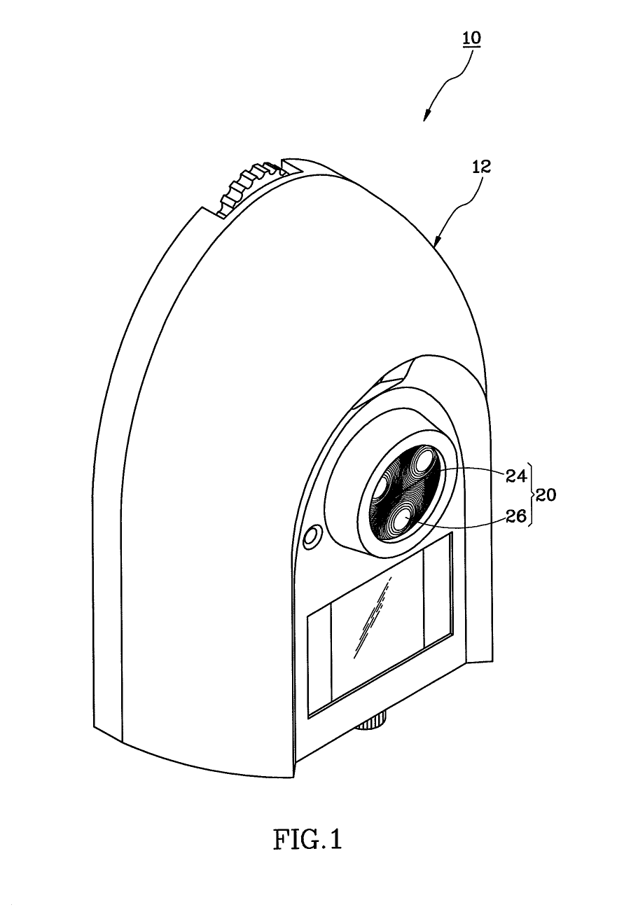

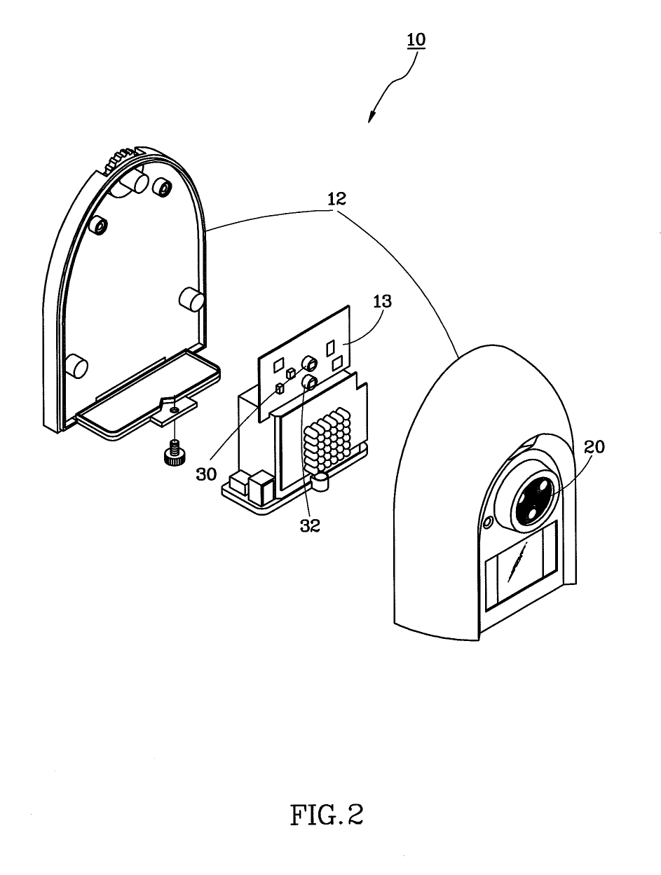

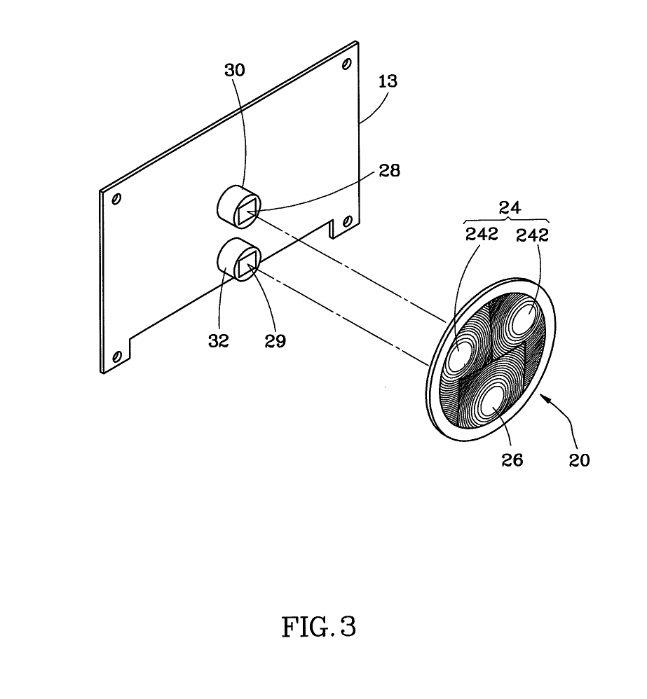

Referring to FIGS. 1-3, a trail camera 10 constructed according to a first preferred embodiment of the present invention is composed of a lens 20 and two sensors 30 and 32. The detailed descriptions and operations of these elements as well as their interrelations are recited in the respective paragraphs as follows.

The lens 20 is mounted to a wall of a shell 12 for collecting and concentrating external environmental light into the shell 12. Each of the sensors 30 and 32 is mounted to a circuit board 13 received inside the shell 12 for receiving the light collected by the lens 20.

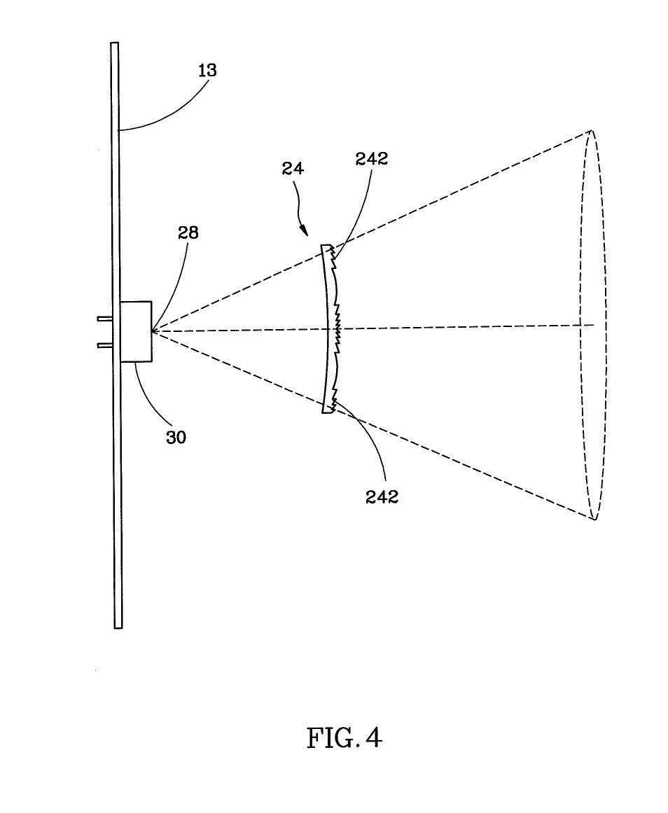

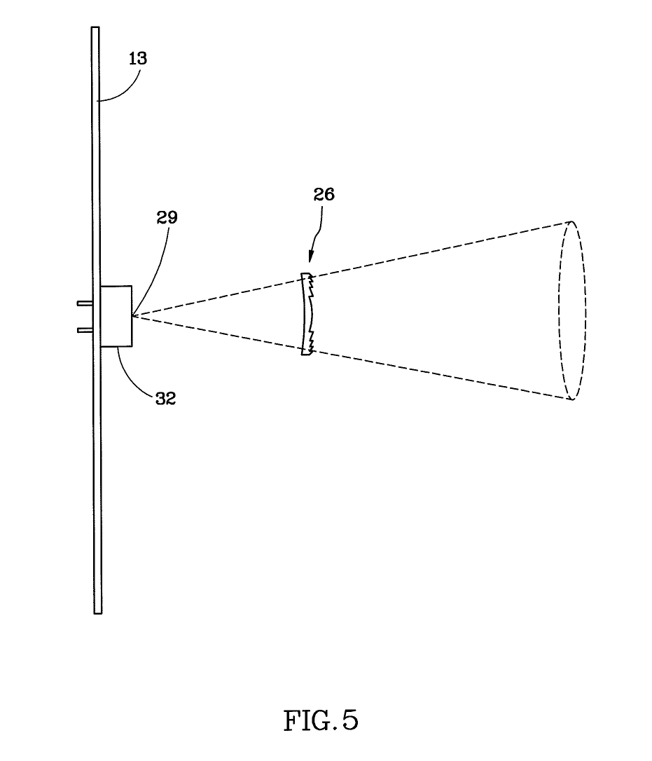

The lens 20 is made of a transparent material and made in one piece or formed of at least two sub-lenses adhesively connected with each other. The lens 20 in this embodiment is a one-piece Fresnel lens having a first sensing area 24 and a second sensing area 26. The first sensing area 24 includes two sub-lenses 242 pieced together. The first and second sensing areas 24 and 26 are located at an upper side and a lower side of the lens 20 separately and the second sensing area 26 is located at the middle position between the two sub-lenses 242. As shown in FIGS. 4-5, the lens 20 is particularly applicable to collection of invisible light (e.g. infrared rays) because of the concentric texture of the Fresnel lens. The first sensing area 24 can collect the light having larger sensing angle than that of the second sensing area from one side of the lens 20 corresponding to the external environment via the two sub-lenses 242 to differentiate the sensing angles of the first and second sensing areas 24 and 26 from each other. The first and second sensing areas 24 and 26 collect the light to form a first focus 28 and a second focus 29 separately. The first and second focuses 28 and 29 do not overlap each other.

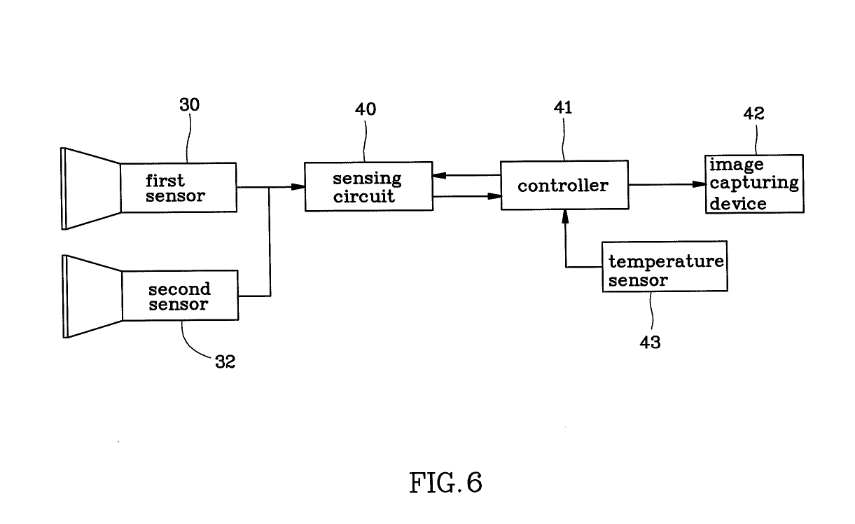

The two sensors in this embodiment are defined as a first sensor 30 and a second sensor 32 separately, each of which can be a pyroelectric infrared sensor or a passive infrared sensor. The first and second sensors 30 and 32 are mounted to the same side of the lens 20 and correspond to the first and second sensing areas 24 and 26 separately to image the first focus 28 onto the first sensor 30 and image the second focus 29 onto the second sensor 32. The first and second sensors 30 and 32 can receive the light from different sensing angles via the first and second sensing areas 24 and 26 separately. The range of angles at which the first sensor 30 can track reaches 45 degrees. In actual practice, the trail camera of the present invention can function as a prey tracker; when the angle for tracking is 45 degrees, larger tracking area can be covered to prevent the prey tracker from tracking the prey only when the prey is very close to the center of the lens 20 for photographing. The range of angles at which the second sensor 32 can track is 10 degrees only. As shown in FIG. 6, when the first and second sensors 30 and 32 receive the light, signals can be amplified by a sensing circuit 40 to generate different trigger signals.

The controller 41 is electrically connected with the two sensors 30 and 32 for receiving the trigger signal from the first sensor 30 or the second sensor 32 via the sensing circuit 40 or for transmitting the signals to the sensing circuit 40. The controller 41 is electrically connected with an image capturing device 42 for transmitting a shutter signal to the image capturing device 42 for photographing after receiving the trigger signal.

In light of the above structure, the user can optionally adopt the first sensor 30 of lager sensing angle or the second sensor 32 of smaller sensing angle for tracking as per the actual circumstance to facilitate changing the tracking area for definitely satisfying the user's needs for different operations. Besides, the two sensors 30 ad 32 have different signal reactions under different temperatures, so the controller 41 can be electrically connected with a temperature sensor 43 to adjust the two-limited comparison voltage of the sensing circuit 40 via the external temperature detected by the temperature sensor 43 to prevent the sensor 30 from being accidentally triggered or failing to be triggered.

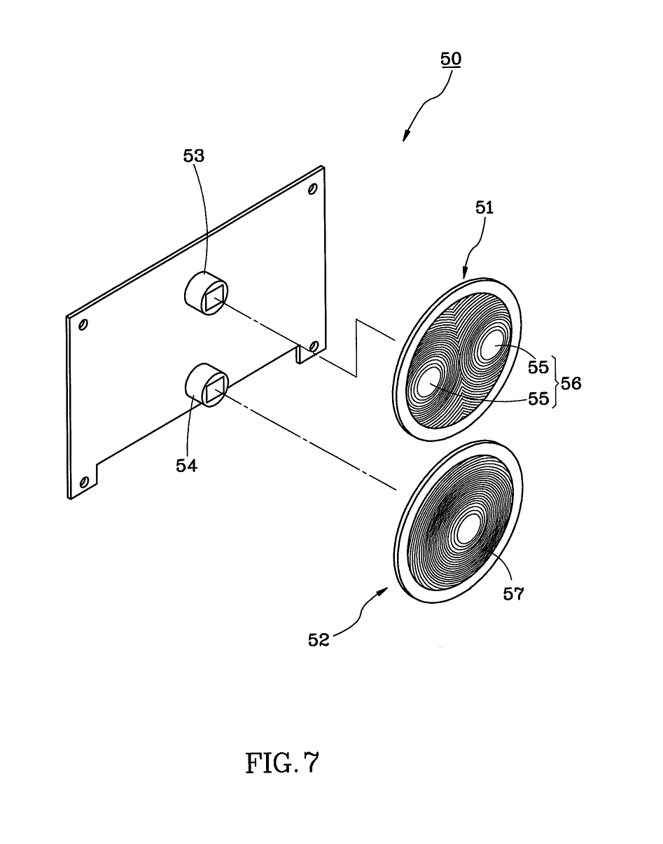

Referring to FIG. 7, a trail camera 50 constructed according to a second preferred embodiment of the present invention is similar to that of the first embodiment, having the differences recited below. The trail camera 50 includes two lenses defined as a first lens 51 and a second lens 52. The first and second lenses 51 and 52 work with the first and second sensors 54 and 54 for collecting and sensing the light. Each of the first and second lenses 51 and 52 is a Fresnel lens. The first lens 51 has a first sensing area 56 formed of two sub-lenses 55. The second lens 52 has a second sensing area 57 formed of one single lens. In this way, the sensing angle of the first lens 51 is different from that of the second lens 52, so the objectives of the present invention can be attained likewise.

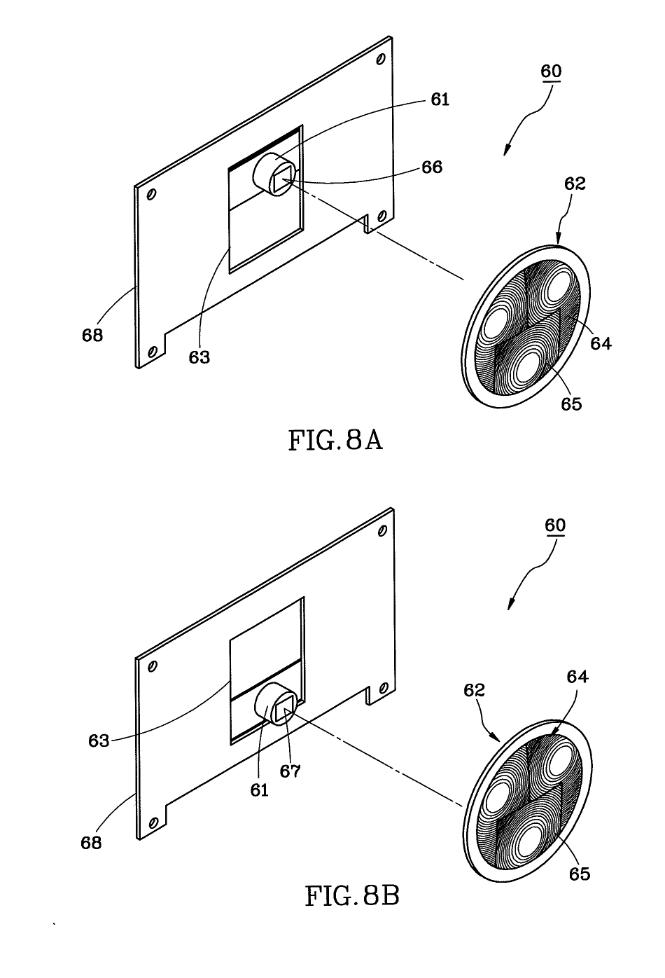

Referring to FIG. 8A and FIG. 8B, a trail camera 60 constructed according to a third preferred embodiment of the present invention is similar to that of the first embodiment, having the differences recited below. The trail camera 60 is composed of a sensor 61, a lens 62, and a control device 63. The lens 62 includes a first sensing area 64 and a second sensing area 65, which have different sensing angles separately. Each of the sensing areas 64 and 65 collects the light to form a first focus 66 or a second focus 67. The first and second focuses 66 and 67 do not overlap each other. The control device 63 in this embodiment is a slidable mechanism mounted to a circuit board 68 for driving the sensor 61 to move or rotate with respect to the circuit board 68 to enable the sensor 61 to correspond to the first focus 66 or the second focus 67 to further focus the light onto the surface of the sensor 61. In light of the aforesaid structure, the user can optionally adopt the sensing area 64 of lager sensing angle or the second sensing area 65 of smaller sensing angle for tracking as per the actual circumstance to facilitate changing the tracking area for definitely satisfying the user's needs for different operations. Besides, the sensor 61 can change the position to focus the light onto the sensor 61; when a plurality of lenses or a lens formed of a plurality of sensing areas is adopted, only one sensor is needed, so the number of the sensor 61 can be reduced for operation.

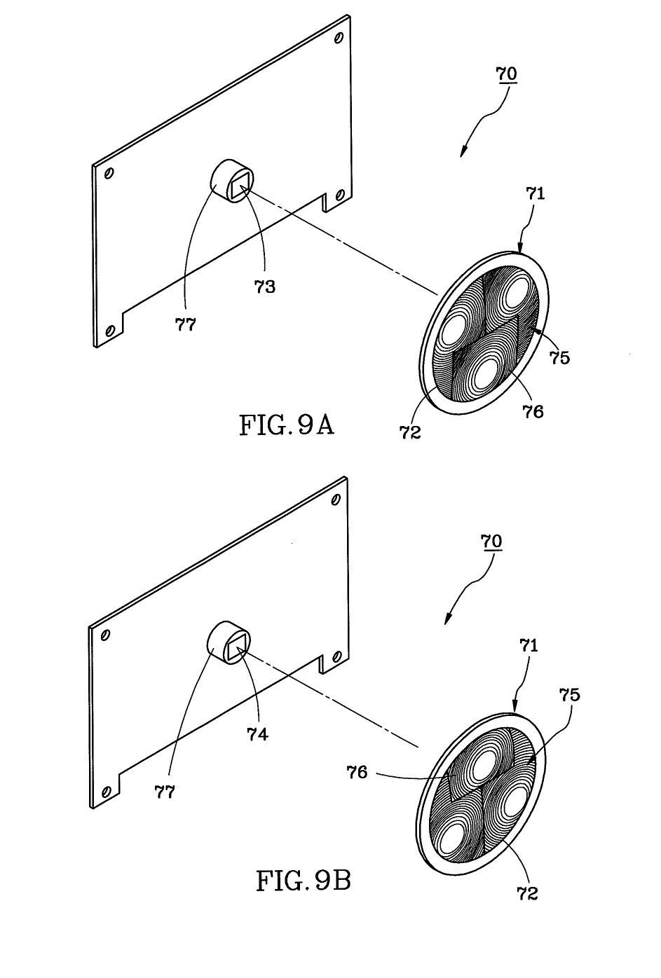

Referring to FIG. 9A and FIG. 9B, a trail camera 70 constructed according to a fourth preferred embodiment of the present invention is similar to that of the third embodiment, having the differences recited below. The controller 71 can directly drive the lens 72 for movement or rotation to focus and image at least one focus 73 or 74 formed while the light passes through the first sensing area 75 or the second sensing area 76 of the lens 72 onto the sensor 77. In light of the aforesaid structure, the control device 71 can change the position of the lens 72 to make the light pass through the lens 72 and focus on the sensor 77, thus decreasing the number of the sensor 77 or the lens 72 for operation.

Although the present invention has been described with respect to specific preferred embodiments thereof, it is in no way limited to the specifics of the illustrated structures but changes and modifications may be made within the scope of the appended

What is claimed is:

1. A trail camera comprising:
a lens having a plurality of sensing areas, the sensing areas having different sensing angles for collecting the light respectively to each form a focus, the focuses not overlapping each other; and
a plurality of sensors each located at an imaging position of one of the focuses, at least one of the sensors being selectively activated to receive the light collected by the sensing areas.

2. The trail camera as defined in claim 1, wherein the lens comprises at least two sub-lenses, each of which has one of the sensing areas.

3. The trail camera as defined in claim 2, wherein at least one of the sub-lenses is a Fresnel lens.

4. The trail camera as defined in claim 1 further comprising a controller, wherein the control device is electrically connected with the sensors; after the sensors receive the light, a trigger signal is generated via a sensing circuit and transmitted to the controller.

5. The trail camera as defined in claim 4 further comprising a temperature sensor, wherein the temperature sensor is electrically connected with the controller for sensing external temperature.

6. The trail camera as defined in claim 4 further comprising an image capturing device, wherein the image capturing device is electrically connected with the controller for receiving a shutter signal of the controller for photographing.

7. A trail camera comprising:
a plurality of sensors; and
a plurality of lenses, each of which has a sensing area, the sensing areas having different sensing angles respectively for collecting the light respectively to each form a focuses, which do not overlap each other and are imaged onto the sensors respectively, at least one of the sensors being selectively activated to receive the light collected from the sensing areas.

8. The trail camera as defined in claim 7, wherein at least one of the lenses is a Fresnel lens.

9. The trail camera as defined in claim 7 further comprising a controller, wherein the controller is electrically connected with the sensors, each of the sensors generating and transmitting a trigger signal via a sensing circuit to the controller after receiving the light.

10. The trail camera as defined in claim 9 further comprising a temperature sensor, wherein the temperature sensor is electrically connected with the controller for sensing external temperature.

11. The trail camera as defined in claim 9 further comprising an image capturing device, wherein the image capturing device is electrically connected with the controller for receiving a shutter signal of the controller for photographing.

12. A trail camera comprising:
a sensor;
a lens having a plurality of sensing areas, the sensing areas having different sensing angles for collecting the light respectively to each form a focus, each of the focuses not overlapping each other; and
a control device for controlling the sensor or the lens to image one of the focuses onto the sensor

13. The trail camera as defined in claim 12, wherein the control device can move or rotate the sensor to image one of the focuses onto the sensor.

14. The trail camera as defined in claim 12, wherein the control device can move or rotate the lens to image one of the focuses onto the sensor.

15. The trail camera as defined in claim 12, wherein the lens comprises at least two sub-lenses, each of which has one of the sensing areas.

16. The trail camera as defined in claim 15, wherein at least one of the two sub-lenses is a Fresnel lens.

17. The trail camera as defined in claim 12 further comprising a controller, wherein the controller is electrically connected with the sensors, each of the sensors generating and transmitting a trigger signal to the controller via a sensing circuit after receiving the light.

18. The trail camera as defined in claim 17 further comprising a temperature sensor, wherein the temperature sensor is electrically connected with the controller for sensing external temperature.

19. The trail camera as defined in claim 17 further comprising an, image capturing device, wherein the image capturing device is electrically connected with the controller for receiving a shutter signal of the controller for photographing.

20. A trail camera comprising:
a sensor;
a plurality of lenses, each of which has a sensing area, the sensing areas having different sensing angles for collecting the light respectively to each form a focus, the focuses not overlapping each other; and
a control device for controlling the sensor or the lenses to image one of the focuses onto the sensor.

21. The trail camera as defined in claim 20, wherein the control device can move or rotate the sensor to image one of the focuses onto the sensor.

22. The trail camera as defined in claim 20, wherein the control device can move or rotate the lens to image one of the focuses onto the sensor.

23. The trail camera as defined in claim 20, wherein at least one of the lenses is a Fresnel lens.

24. The trail camera as defined in claim 20 further comprising a controller, wherein the controller is electrically connected with the sensors, each of the sensors generating and transmitting a trigger signal to the controller via a sensing circuit after receiving the light.

25. The trail camera as defined in claim 24 further comprising a temperature sensor, wherein the temperature sensor is electrically connected with the controller for sensing external temperature.

26. The trail camera as defined in claim 24 further comprising an image capturing device, wherein the image capturing device is electrically connected with the controller for receiving a shutter signal of the controller for photographing.

27. The trail camera as defined in claim 1, wherein the lens is formed in one piece or formed of at least two sub-lenses adhesively connected with each other.

28. The trail camera as defined in claim 7, wherein the lens is formed in one piece or formed of at least two sub-lenses adhesively connected with each other.

29. The trail camera as defined in claim 12, wherein the lens is formed in one piece or formed of at least two sub-lenses adhesively connected with each other.

30. The trail camera as defined in claim 20, wherein the lens is formed in one piece or formed of at least two sub-lenses adhesively connected with each other.

31. The trail camera as defined in claim 1, wherein at least one of the sensors comprises a pyroelectric infrared sensor or a passive infrared sensor.

32. The trail camera as defined in claim 7, wherein at least one of the sensors comprises a pyroelectric infrared sensor or a passive infrared sensor.

33. The trail camera as defined in claim 12, wherein the sensor comprises a pyroelectric infrared sensor or a passive infrared sensor.

34. The trail camera as defined in claim 20, wherein the sensor comprises a pyroelectric infrared sensor or a passive infrared sensor.
